(19) United States
(12) Patent Application Publication
(10) Pub. No.: US 2014/0157949 A1
(43) Pub. Date: Jun. 12, 2014

(54) CRANKSET FOR A BICYCLE

(71) Applicant: SPECIALIZED BICYCLE COMPONENTS, INC., Morgan Hill, CA (US)

(72) Inventor: Aaron J. Foley, Morgan Hill, CA (US)

(73) Assignee: SPECIALIZED BICYCLE COMPONENTS, INC., Morgan Hill, CA (US)

(21) Appl. No.: 13/711,957

(22) Filed: Dec. 12, 2012

(51) Int. Cl. B62M 1/36

(52) U.S. Cl. CPC B62M 1/36
USPC 74/594.2

(57) ABSTRACT

A bicycle crankset including a first crank and a second crank, and a spider that secures at least one chain ring to the crankset Each of the first crank and the second crank has an end adapted to engage a pedal. The crankset also includes a spindle extending between and engaged with the first crank and the second crank. The spindle includes a radially extending arm and a protrusion disposed on the arm, and the arm co-molded with the spider to transmit torque to the spider.

### BACKGROUND

The present invention relates to a crankset for a bicycle, and more particularly to a bicycle crankset including a spindle and a spider coupled to the spindle.

Typically, bicycles are propelled by pedals mounted to a crankset The crankset includes two crank arms—a drive crank arm and a non-drive crank arm—interconnected to each other by a spindle. A pedal is coupled to a distal end of each crank arm opposite the end of the crank arm that is coupled to the spindle. Also, a spider is typically coupled to the drive crank arm. These cranksets transfer energy exerted on the pedals by a rider to forward motion of the bicycle by transferring force through the crank arms and the spider to one or more chain rings that are coupled to the spider and that engage a chain to transfer the rotary motion of the crankset to a rear wheel.

### SUMMARY

The present invention provides a bicycle crankset including a first crank and a second crank. Each of the first crank and the second crank has an end that is adapted to engage a pedal. In one construction, the crankset also includes a spider that secures at least one chain ring to the crankset, and a spindle extending between and engaged with the first crank and the second crank. The spindle includes a radially extending arm and a protrusion disposed on the arm, and the arm is co-molded with the spider to transmit torque to the spider.

In another construction, the crankset also includes a spider that attaches at least one chain ring to the crankset, and a spindle extending between and engaged with the first crank and the second crank. The spindle includes a radially extending arm that is co-molded with the spider to transmit torque to the spider, and the arm defines a hole that receives a fastener to secure the chain ring to the spider.

In another construction, the crankset also includes a composite spider that attaches at least one chain ring to the crankset, and a spindle extending between and engaged with the first crank and the second crank. The spindle includes radially extending arms angularly spaced from each other and interlocked into the composite spider to transmit torque to the spider.

Other aspects of the invention will become apparent by consideration of the detailed description and accompanying drawings.

### BRIEF DESCRIPTION OF THE DRAWINGS

FIG. 1 is a side view of a bicycle including a crankset embodying the present invention.

FIG. 2 is a perspective view of the crankset including first and second crank arms interconnected by a spindle.

FIG. 3 is a section view of the crankset of FIG. 2 taken along line 3-3.

FIG. 4 is an exploded view of the crankset of FIG. 2 illustrating the first and second crank arms, the spindle, a spider, and bearings.

FIG. 5 is a section view of the crankset of FIG. 2 taken along line 5-5 and illustrating the spindle co-molded with the second crank arm.

FIG. 6 is a perspective view of the spindle including radially extending arms and protrusions disposed on the ends of the arms.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

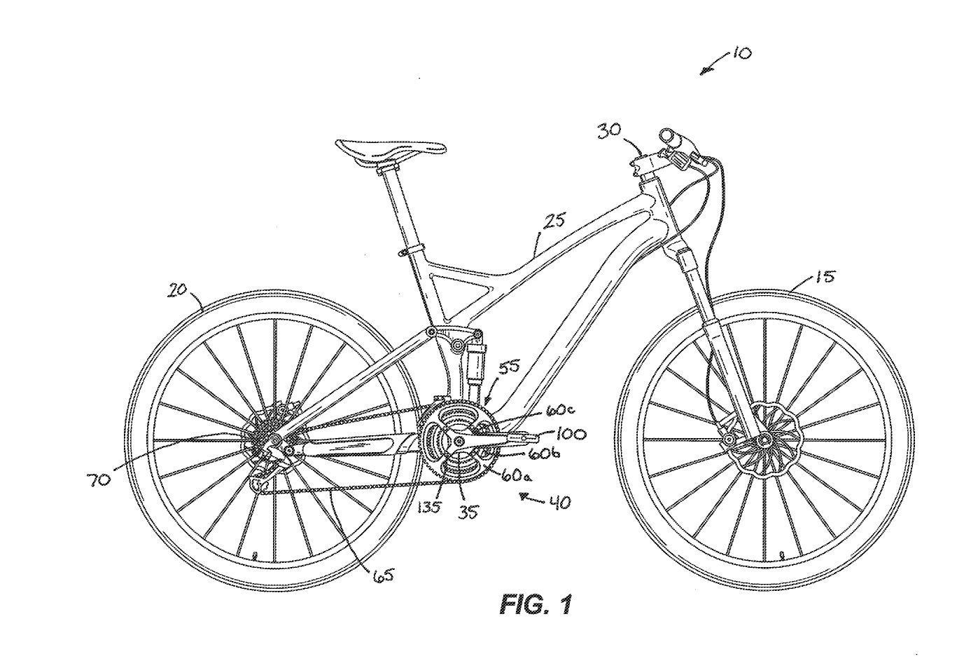

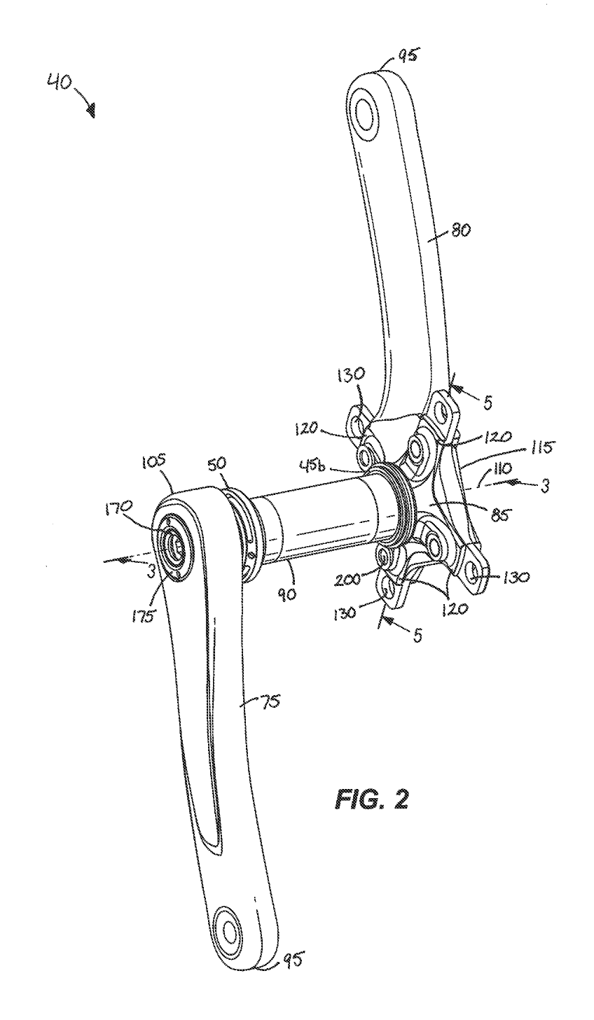

FIG. 1 illustrates a bicycle 10 that includes a front wheel 15, a rear wheel 20, a frame 25, and a steering assembly 30. The frame 25 includes a bottom bracket 35 defining an opening (not shown) into which a bottom bracket shell (not shown) is positioned to rotationally couple a crankset 40 to the frame 25. With reference to FIGS. 2-4, bearings 45 (e.g., cartridge bearings, cone bearings, etc.) that engage the shell are coupled to the crankset 40 to support rotation of the crankset 40. As illustrated, a bearing preload mechanism 50 is disposed adjacent one of the bearings 45 to preload the bearing 45, although the bearings 45 can be preloaded in other ways. Referring back to FIG. 1, a sprocket assembly 55 is coupled to the crankset 40 and includes one or more chain rings 60 that couple to a chain 65. The chain 65 engages the rear wheel 20 through a rear sprocket assembly 70 to propel the bicycle 10.

With reference to FIGS. 1 and 2, the crankset 40 includes a first crank 75 defining a non-drive side of the crankset 40, a second crank 80 defining a drive side of the crankset 40, a spider 85, and a spindle 90 extending between the first and second cranks 75, 80 and coupled to the spider 85. The first and second cranks 75, 80 include first or free ends 95 to which pedals 100 (one shown) are attached, and second ends 105 that are coupled to the spindle 90 to allow a rider to rotate the crankset 40 about an axis 110 extending through the spindle 90 to propel the bicycle 10. The illustrated first and second cranks 75, 80 are formed of composite material, although the cranks 75, 80 can be formed of other metallic or non-metallic material.

As illustrated in FIGS. 2, 4, and 5, the spider 85 is formed of composite material and is molded with the second crank 80 such that the body of the spider 85 is integrated into the body of the second crank 80 to form an integrated crank-spider element 115. The body of the spider 85 can be hollow or solid. In other constructions, the spider 85 can be provided as a separate component relative to the second crank 80 (e.g., the spider 85 can be removably attached to the crank 80).

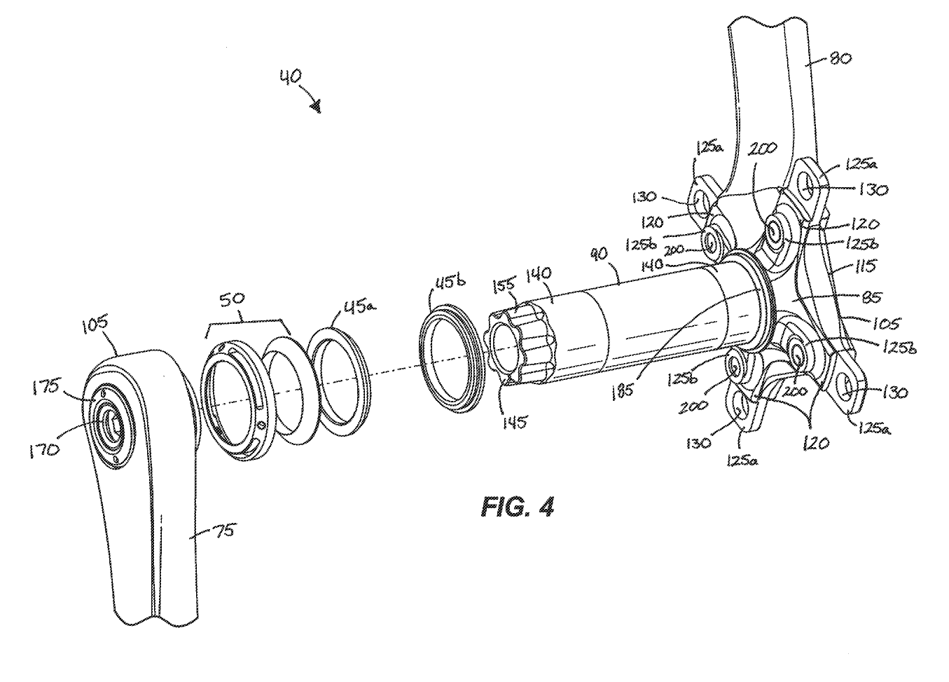

With reference to FIGS. 2 and 4, the spider 85 defines radially extending chain ring portions 120 that attach the chain rings 60 to the crankset 40. The illustrated spider 85 has four chain ring portions 120 or spokes angularly spaced around the axis 110, although the spider 85 can have a different quantity of chain ring portions 120. While the illustrated spider 85 has a wheel spoke profile, the spider 85 can be defined by a disc-shaped or polygonal-shaped (e.g., square) profile.

Each chain ring portion 120 has two radially aligned chain ring attachments 125a, 125b to attach three different-sized chain rings 60 to the crankset 40. The quantity of chain ring attachments 125a, 125b provided on each chain ring portion 120 depends on the quantity and arrangement of chain rings 60 to be attached to the crankset 40. With reference to FIGS. 1, 4, and 5, the outermost chain ring attachment 125a has a hole 130 through which a fastener 135 (e.g., rivet, bolt, etc.) is inserted to attach a large-sized chain ring 60a and a medium-sized chain ring 60b to the crankset 40. The large-sized chain ring 60a is coupled to an exterior shoulder 137 of the chain ring attachment 125a, and the medium-sized chain ring 60b is attached an interior shoulder 138 of the chain ring attachment 125a. As described in detail below, the innermost chain ring attachment 125b receives another fastener 135 to attach the smaller chain ring 60a to the crankset 40.

The spindle 90 rotates about the axis 110 and defines bearing surfaces 140 adjacent both ends of the spindle 90 to support the bearings 45. The illustrated spindle 90 is hollow and is formed from a single unitary body, although the spindle 90 can be multiple pieces, such as a two-piece spindle with first and second spindle portions coupled to each other near the center of the spindle 90. The spindle 90 can be formed from metal (e.g., titanium, steel, aluminum, etc.), a metal alloy, or other durable composites.

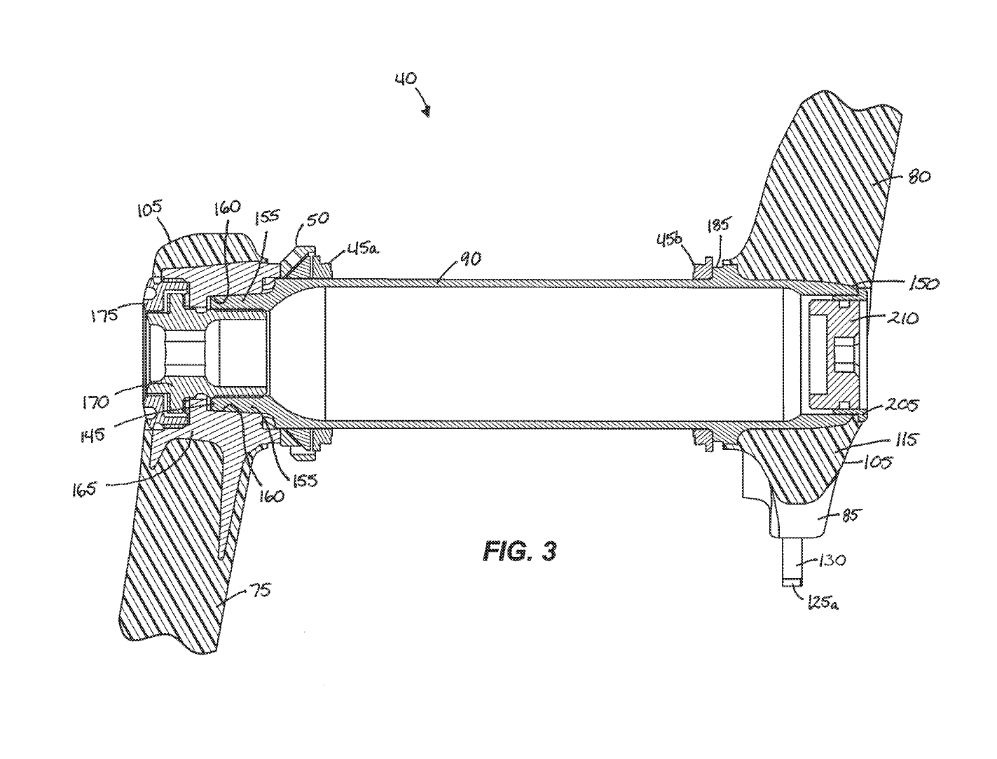

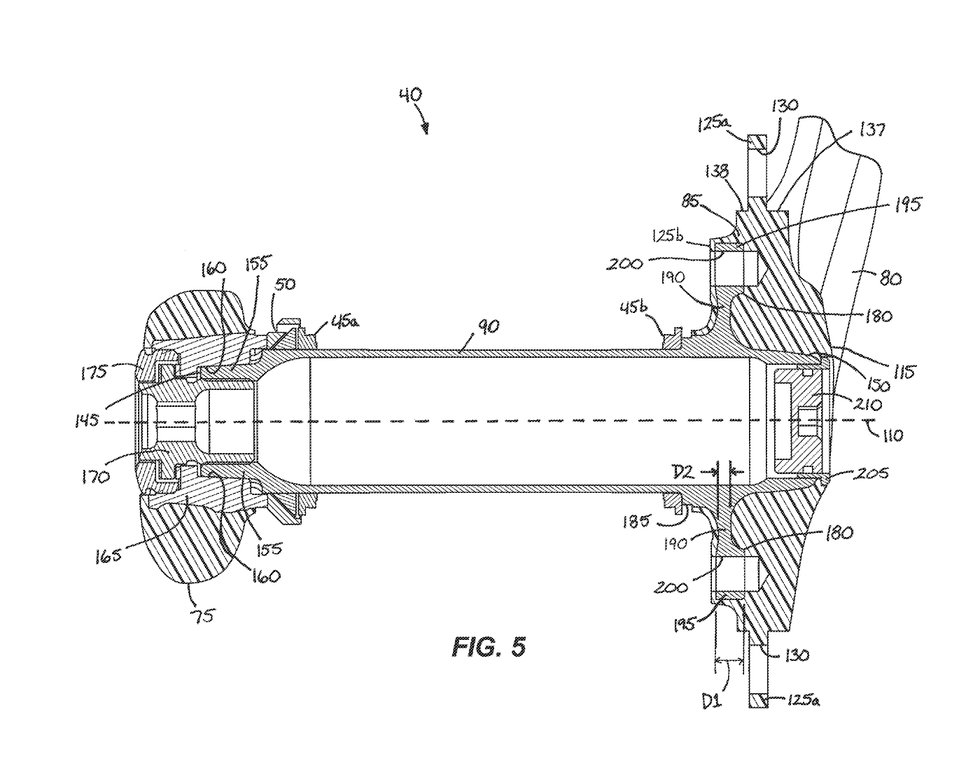

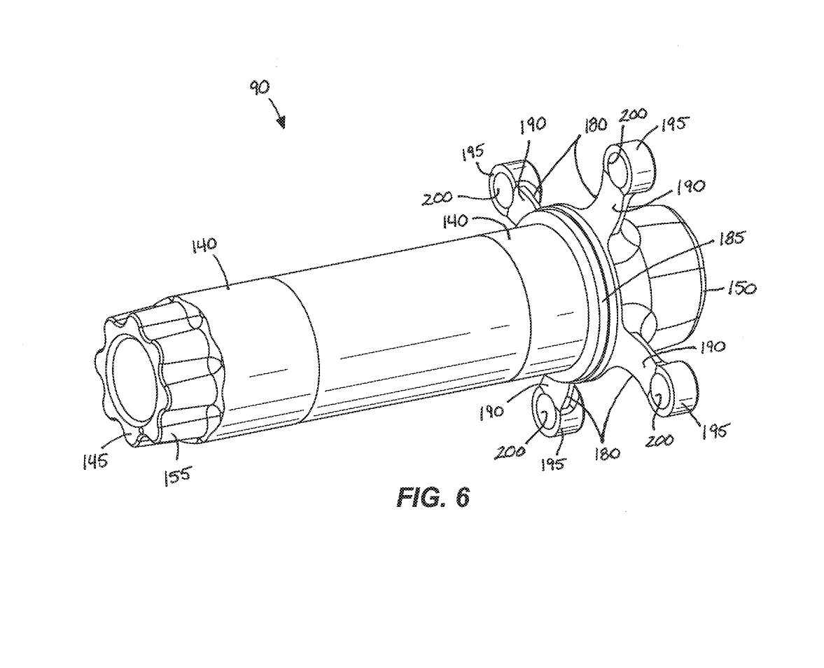

FIGS. 2, 3, 5, and 6 show that the spindle 90 has a first end 145 engaged with the first crank 75 and a second end 150 engaged with the second crank 80. With reference to FIG. 6, the first end 145 defines a plurality of external cogs or splines 155 extending circumferentially around the first end 145. FIGS. 3 and 5 illustrate that the external splines 155 engage corresponding internal splines 160 of a first insert 165 molded into the first crank 75. A first plug 170 is threaded into the first end 145 to secure the spindle 90 for rotation with the first crank 75, and a cap 175 is threaded into the insert 165 to provide a decorative cover and to inhibit entrainment of dirt, water, and other debris.

With reference to FIGS. 3, 5, and 6, the second end 150 is defined by a slightly tapered cylindrical portion that is coupled internally to the second crank 80. The illustrated spindle 90 also includes four radially-extending arms 180 that are proximate to and located inward from the second end 150, and a shoulder 185 located inward relative to the radial arms 180 to define a bearing stop on the spindle 90. As illustrated in FIG. 6, the four arms 180 are equally angularly spaced apart from each other around the axis 110. Each arm is defined by a stem 190 and a knob or protrusion 195 that is coupled to an outer end of the stem 190. Each protrusion 195 has an axial dimension D1 (parallel to the axis 110) that is greater than a corresponding axial dimension D2 at a location on the corresponding stem 190.

Referring to FIGS. 3 and 5, the second end 150 and the arms 180 are co-molded with the crank-spider element 115 to secure the spindle 90 for rotation with the second crank 80. The illustrated protrusions 195 define a portion of the inner chain ring attachment 125b and are drilled and tapped (i.e., threaded) to form holes 200 (e.g., blind holes) that receive the fasteners 135 to secure the smaller chain ring 60c to the crank-spider element 115 and the spindle 90. In the illustrated construction, the holes 200 are drilled and tapped after the spindle 90 is integrated into the crank-spider element 115 so that the chain ring attachment 125b and the arms 180 cooperatively define the holes 200. A second insert 205 is coupled (e.g., threaded into, adhered, permanently secured, etc.) to the inside wall of the spindle 90, and a second plug 210 is threaded into the second insert 205 to enclose the hollow interior of the spindle 90.

To assemble the illustrated crankset 40, the first crank 75 and the first insert 165 are co-molded together and the spindle 90 is co-molded with the integrated crank-spider element 115. After the composite components have cured, the drive-side bearing 45b is arranged on the bearing surface 140 adjacent the shoulder 185 and the non-drive side bearing 45a is arranged on the bearing surface 140 adjacent the first end 145 of the spindle 90. In constructions including the bearing preload mechanism 50, the mechanism 50 is placed on the spindle 90 adjacent the non-drive side bearing 45a to apply a preload to the bearing. The first end 145 of the spindle 90 is then inserted into the first insert 165 so that the external and internal splines 155, 160 mesh with each other. The first plug 170 is threaded into the first end 145 of the spindle 90 to hold the first crank 75 and the spindle 90 in engagement with each other. The cap 175 is attached to the first plug 170 to substantially enclose the first end 145 of the spindle 90, and the second insert 205 and the second plug 210 are attached to the second end 150 of the spindle 90 to enclose the second end 150 of the spindle 90.

The chain rings 60a-c are attached to the integrated crank-spider element 115 and the spindle 90 by aligning holes (not shown) in the chain rings 60 with the inner and outer chain ring attachments 125a, 125b and securing the chain rings 60a-c using the fasteners 135. The radial arms 180 are interlocked into the spider 85 so that the second crank 80 is secured to the spindle 90 to prevent the second crank 80 from spinning relative to the spindle 90 when a force is applied to the pedals 100. That is, the rigid connection provided by the co-molded structure of the second crank 80, the spider 85, and the spindle 90 transmits torque generated by the pedal force through the spider 85 to the chain rings 60 without significant, if any, lost motion.

Various features and advantages of the invention are set forth in the following claims.

1. A crankset for a bicycle, the crankset comprising:
a first crank and a second crank, each of the first crank and the second crank having an end adapted to engage a pedal;
a spider that secures at least one chain ring to the crankset; and
a spindle extending between and engaged with the first crank and the second crank, the spindle including a radially extending arm and a protrusion disposed on the arm, the arm co-molded with the spider to transmit torque to the spider.

2. The crankset of claim 1, wherein the spindle includes a plurality of radially extending arms angularly spaced from each other and a protrusion disposed on each of the arms, and wherein each of the arms is co-molded with the spider.

3. The crankset of claim 1, wherein an end of the spindle is co-molded with the second crank.

4. The crankset of claim 3, wherein the second crank and the spider are molded together from a composite material to form an integrated second crank and spider.

5. The crankset of claim 1, wherein the protrusion is disposed on a radially-outer end of the arm.

6. The crankset of claim 1, wherein a first end of the spindle defines a plurality of cogs extending circumferentially around the first end and engageable with the first crank to secure the spindle for rotation with the first crank, and wherein a second end of the spindle opposite the first end is co-molded with the spider and the second crank to secure the spindle for rotation with the second crank.

7. A crankset for a bicycle, the crankset comprising:
a first crank and a second crank, each of the first crank and the second crank having an end adapted to engage a pedal;
a spider that attaches at least one chain ring to the crankset; and
a spindle extending between and engaged with the first crank and the second crank, the spindle including a radially extending arm co-molded with the spider to transmit torque to the spider,
wherein the arm defines a hole that receives a fastener to secure the chain ring to the spider.

8. The crankset of claim 7, wherein the hole is drilled and tapped to threadably receive the fastener.

9. The crankset of claim 8, wherein the spindle includes a plurality of arms and a protrusion disposed on an end of each of the arms, and wherein each protrusion partially defines one hole to receive the fastener.

10. The crankset of claim 9, wherein each of the arms and each protrusion is co-molded with the spider.

11. The crankset of claim 7, wherein a first end of the spindle defines a plurality of cogs extending circumferentially around the first end and engageable with the first crank to secure the spindle for rotation with the first crank.

12. The crankset of claim 11, wherein the second crank and the spider are molded together from a composite material to form an integrated second crank-spider element, and wherein a second end of the spindle is co-molded with the second crank-spider element to secure the spindle for rotation with the second crank.

13. The crankset of claim 7, wherein the spider and the arm cooperatively define the hole that receives the fastener.

14. A crankset for a bicycle, the crankset comprising:
a first crank and a second crank, each of the first crank and the second crank having an end adapted to engage a pedal;
a composite spider that attaches at least one chain ring to the crankset; and
a spindle extending between and engaged with the first crank and the second crank, the spindle including radially extending arms angularly spaced from each other and interlocked into the composite spider to transmit torque to the spider.

15. The crankset of claim 14, wherein the spindle is co-molded with the composite spider.

16. The crankset of claim 14, wherein the spindle further includes a protrusion disposed on an end of each of the arms, and wherein the spider and the protrusions cooperatively define holes that receive fasteners to secure the chain ring to the spider and the spindle.

17. The crankset of claim 16, wherein each of the arms and each protrusion is co-molded with the spider.

18. The crankset of claim 16, wherein each hole is drilled and tapped to threadably receive the fastener.

19. The crankset of claim 14, wherein a first end of the spindle defines a plurality of cogs extending circumferentially around the first end and engageable with the first crank to secure the spindle for rotation with the first crank.

20. The crankset of claim 19, wherein the second crank and the spider are molded together to form an integrated composite crank-spider element, and wherein a second end of the spindle is co-molded with the crank-spider element to secure the spindle for rotation with the second crank.
